(19) United States
(12) Patent Application Publication
(10) Pub. No.: US 2021/0344262 A1
(43) Pub. Date: Nov. 4, 2021

(54) LAMINATED SQUIRREL CAGE ROTOR

(71) Applicant: Honeywell International Inc., Morris Plains, NJ (US)

(72) Inventors: Jens Gehrke, Rancho Palos Verdes, CA (US); Leroy Fizer, Huntington Beach, CA (US); James Piascik, Randolph, NJ (US); Martin Baker, Morristown, NJ (US)

(21) Appl. No.: 16/861,667

(22) Filed: Apr. 29, 2020

(51) Int. Cl. H02K 15/00; H02K 17/16; H02K 15/02

(52) U.S. Cl. CPC H02K 15/0012; H02K 15/02; H02K 17/165

(57) ABSTRACT

A method for forming a squirrel cage rotor includes stacking a plurality of coated laminates to form a stacked laminate core preform. The stacked laminate core preform defines a plurality of open cavities. Each coated laminate of the plurality of coated laminates includes a laminate coated with a precursor layer. The precursor layer includes a binder and glass particles. The method further includes firing the stacked laminate core preform at a temperature above the softening point of the glass particles to form a low porosity rotor core. The method further includes casting a conductive material into the plurality of open cavities formed in the rotor core to define a conductive squirrel cage structure in the low porosity rotor core.

### TECHNICAL FIELD

The present disclosure relates to techniques for manufacturing squirrel cage rotors for induction machines.

### BACKGROUND

A motor includes, in some examples, a fixed stator and a rotor positioned in the stator. The stator produces a rotating magnetic field and the rotor that produces a static magnetic field. In response to the rotating magnetic field of the stator, the rotor rotates within the stator to produce torque. In an induction motor, the rotating magnetic field of the stator may induce an electric current in the rotor, which produces the magnetic field of the rotor. An efficiency of the induction motor may be related to a magnitude and uniformity of the induced magnetic field of the rotor.

### SUMMARY

The disclosure describes, in some examples, systems and techniques for manufacturing squirrel cage rotors for an induction machine having improved efficiency and/or at improved yield. The rotor core structure may be formed form laminate layers using a glass laminate process. The laminate layers each include a binder and glass (e.g., glass particles) on a laminate. The laminate layers are stacked and fired to form a rotor core with low porosity. Aluminum, copper, and/or another conductive material may be cast into open cavities in the body of the core to form rotor bars that define the “squirrel cage” structure. The low porosity of the glass laminate rotor core body reduces or prevents the conductive material from infiltrating into the core body during the casting process and forming short circuits between adjacent rotor bars.

In some examples, the disclosure describes a method for forming a squirrel cage rotor. The method includes stacking a plurality of coated laminates to form a stacked laminate core preform. The stacked laminate core preform defines a plurality of open cavities. Each coated laminate of the plurality of coated laminates includes a laminate coated with a precursor layer. The precursor layer includes a binder and glass particles. The method further includes firing the stacked laminate core preform at a temperature above the softening point of the glass particles to form a low porosity rotor core. The method further includes casting a conductive material into the plurality of open cavities formed in the rotor core to define a conductive squirrel cage structure in the low porosity rotor core.

In some examples, the disclosure describes a squirrel cage rotor that includes a rotor core and a squirrel cage structure. The rotor core includes a plurality of laminates and a plurality of interlaminate dielectric layers interspersed or interposed with the plurality of laminates in an alternating relationship. Each laminate of the plurality of laminates includes a magnetically-permeable material. Each interlaminate dielectric layer of the plurality of interlaminate dielectric layers includes glass particles. The squirrel cage structure includes distal and proximal shorting rings and a plurality of rotor bars extending longitudinally along the rotor core between the distal and proximal end caps.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a side view diagram illustrating an example rotor for an induction motor.

FIG. 1B is a cross-sectional diagram illustrating an example rotor core of the rotor of FIG. 1A.

FIG. 1C is a cross-sectional diagram illustrating an example rotor squirrel cage of the rotor of FIG. 1A.

FIG. 2 is a flowchart illustrating one or more techniques forming a squirrel cage rotor.

FIG. 3A is a cross-sectional diagram illustrating an example coated laminate.

FIG. 3B is a cross-sectional diagram illustrating two example coated laminates.

FIG. 3C is a cross-sectional diagram illustrating an example stacked laminate core preform.

FIG. 3D is a cross-sectional diagram illustrating an example low porosity rotor core.

FIG. 3E is a side view diagram illustrating an example low porosity rotor core.

FIG. 3F is a side view diagram illustrating an example squirrel cage structure formed from the example low porosity rotor core of FIG. 3E.

### DETAILED DESCRIPTION

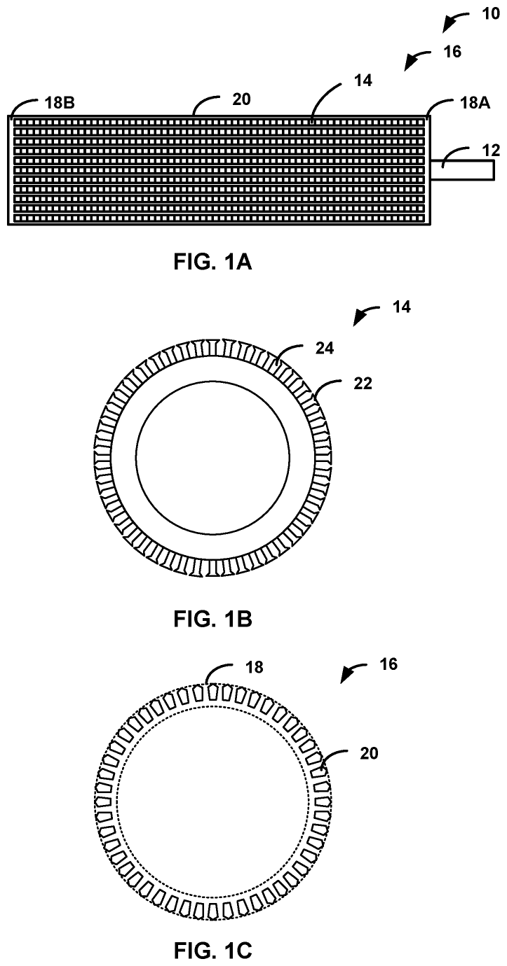

The disclosure describes, in some examples, systems and techniques for manufacturing squirrel cage rotors for an induction machine having improved efficiency and/or at improved yield. FIG. 1A is a side view diagram of an example rotor 10 for an induction motor. Rotor 10 may be part of a variety of electromagnetic devices including, but not limited to, motors, generators, sensors (e.g., RVDTs and motor resolvers), actuators, magnetic bearings, and the like. Rotor 10 includes a shaft 12, a rotor core 14 coupled to shaft 12, and a squirrel cage structure 16 positioned around rotor core 14. Shaft 12 is configured to transfer torque to a rotary structure or machine, such as a propulsor.

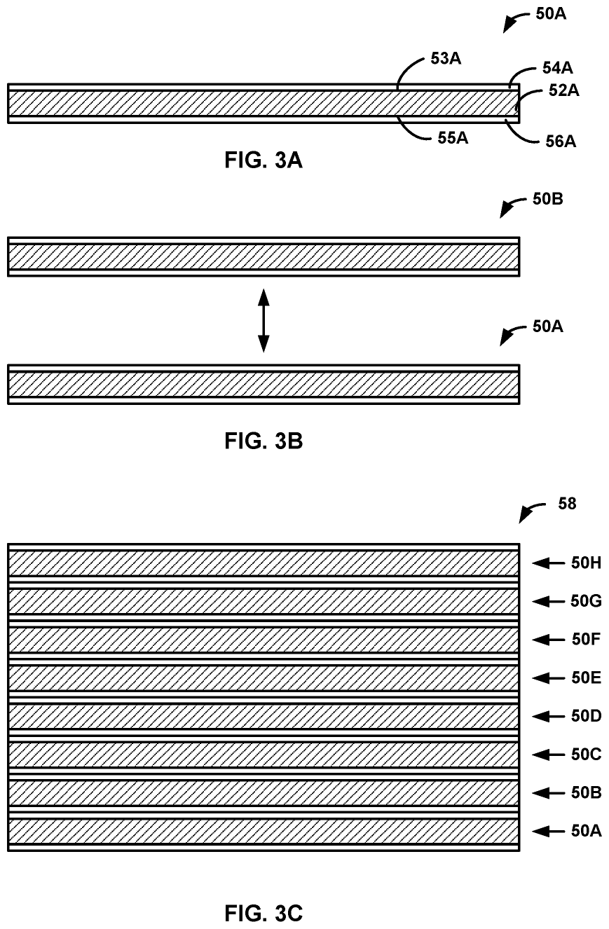

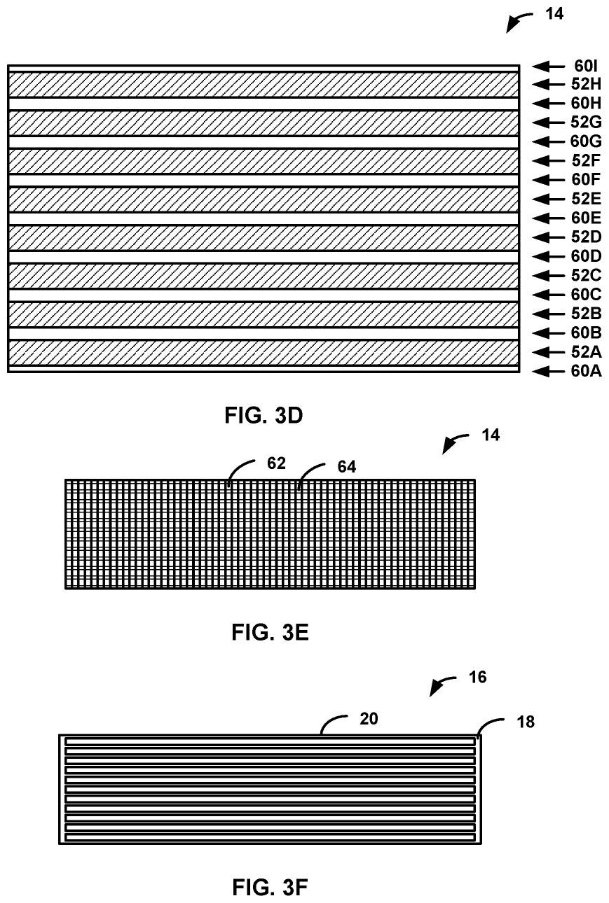

Rotor core 14 is configured to carry a magnetic field. Rotor core 14 may include a plurality of laminates separated by a plurality of interlaminate dielectric layer, as will be described further in FIGS. 3A-3C. Each laminate of the plurality of laminates may include a magnetically-permeable material, while each interlaminate dielectric layer of the plurality of interlaminate dielectric layers may include glass and/or another low porosity insulative material. The interlaminate dielectric layers may suppress eddy currents from circulating through rotor core 14. FIG. 1B is a cross-sectional diagram of the example rotor core 14 of rotor 10 of FIG. 1A. Rotor core 14 includes a plurality of rotor teeth 22 and a plurality of open cavities 24 between adjacent teeth of the plurality of rotor teeth 22. In some examples, a width of each rotor tooth of the plurality of rotor 22 teeth is less than about 0.1 inches although other values are contemplated.

Rotor core 14 may be a low porosity (e.g., volume fraction of pores) rotor core. For example, rotor core 14 may have a porosity of less than about 5%. In some examples, rotor core 14 may have sufficiently low porosity (e.g., open porosity extending between adjacent open cavities) such that a conductive material having a viscosity greater than about 1.0 mPa*s at a pressure of about 1000 psi may not substantially flow between adjacent open cavities of the plurality of open cavities 24. For example, rotor core 14 may have an open porosity less than about 5%.

Referring back to FIG. 1A, squirrel cage structure 16 includes a plurality of rotor bars 20 extending longitudinally between two shorting rings 18A and 18B (referred to collectively as “shorting rings 18”). Squirrel cage structure 16 may include an electrically conductive material. The plurality of rotor bars 20 is configured to conduct an induced electric current. FIG. 1C is a cross-sectional diagram of an example squirrel cage structure 16 of rotor 10 of FIG. 1A. Each rotor bar 20 corresponds to an open cavity of the plurality of open cavities 24 of rotor core 14 described in FIG. 1B. The plurality of rotor bars 20 may be isolated from each other, such that the plurality of rotor bars 20 produce a relatively uniform electrical current.

In operation, rotor 10 may be positioned in a stator. The stator produces a rotating magnetic field that induces a voltage in the plurality of rotor bars 20 and creates short-circuit currents in the plurality of rotor bars 20. These short-circuit currents create a magnetic field that interacts with the rotating magnetic field of the stator and causes rotor 10 to rotate within the stator to produce torque. In this way, rotor 10 may create torque in response to receiving a magnetic current from the stator.

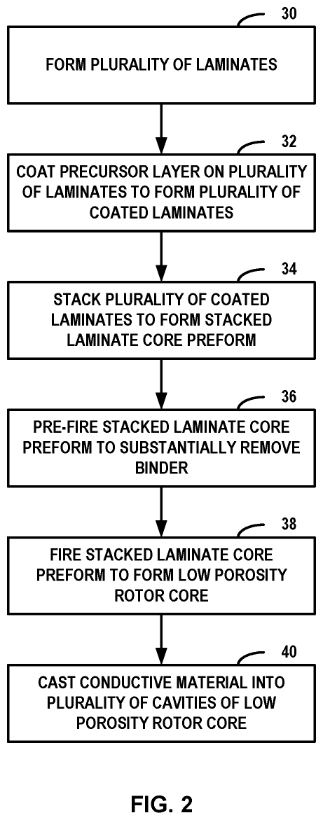

During manufacture of rotor 10, a conductive material may be cast into the plurality of open cavities 24 in rotor core 14 to define the plurality of rotor bars 20 of squirrel cage structure 16, as will be described further in FIG. 2 below. Prior to forming rotor core 14, laminates that form rotor core 14 may include open pores that extend between adjacent open cavities, and stacks of laminates may include gaps or other spaces in between adjacent laminates. During casting, the conductive material may be under high pressure, and may flow into any open pores or gaps in laminations of rotor core 14.

In rotor cores that include silicon steel laminations, after the conductive material cools to form the rotor bars, conductive material in the open pores or gaps may form conductive bridges between adjacent rotor bars. This interlaminar bridging may cause shorting between the adjacent rotor bars and result in an uneven magnetic field that generates a reduced amount of torque. This interlaminar bridging may result in low yield of rotors that have a high number of rotor teeth and/or a low spacing between rotor teeth. The interlaminar bridging may also limit a pressure that may be used to flow the conductive material, thereby limiting a size of rotor bars to a length of the rotor. For example, to adequately infiltrate the plurality of open cavities and flow the conductive material along an entire length of the plurality of open cavities, a relatively high pressure may be applied to the conductive material during casting. However, to limit interlaminar flow of the conductive material, a relatively low pressure may be used. As a result of this relatively low pressure, the rotor may have a relatively high ratio of open cavity width to rotor length.

To prevent or reduce conductive material from flowing into the pores or interlaminar gaps, a ceramic paint may be applied to surfaces that may be exposed to a melted conductive material. Alternatively, to remove bridges formed by the conductive material, the rotor core may be quenched to attempt to break the bridges or etched to remove interlaminar conductive material. However, these processes may add complexity and expense to manufacture of the rotors, and may have limited success in reducing or removing bridging in the rotor bars.

Example rotor cores discussed herein may be configured to reduce interlaminar flow of conductive material between the plurality of rotor bars 20 during formation of the plurality of rotor bars 20 by sealing surfaces of rotor core 14 that may be exposed to the conductive material with continuous, low porosity interlaminate dielectric layers glass prior to formation of the plurality of rotor bars 20. This low porosity glass may fill open pores or gaps in laminations of rotor core 14 to reduce interlaminar flow of conductive material, and subsequent interlaminar bridging, between adjacent rotor bars, thus enabling smaller widths of the plurality of open cavities 24 and, correspondingly, a greater number of the plurality of rotor bars 20.

Example rotor cores discussed herein may include other advantageous properties due to incorporation of interlaminate dielectric layers. In some examples, rotor cores discussed herein may provide insulation and bonding of laminates for high temperature applications. For example, the interlaminate dielectric layers may be substantially free of organic materials. As a result, rotor cores discussed herein may provide prolonged and reliable operation at highly elevated temperatures (e.g., temperatures >260° C.) at which organic materials tend to breakdown and decompose. In some examples, rotor cores discussed herein may increase a rigidity of the rotor. For example, the interlaminate dielectric layers may be substantially continuous. As a result, the rotor may have improved rotor dynamics.

FIG. 2 is a flowchart illustrating one or more techniques forming squirrel cage rotors described herein. FIG. 2 will be described with respect to FIGS. 3A-3C, which illustrate various stages of forming rotor core 14. However, it will be understood that other rotor cores may be formed using the techniques of FIG. 2.

In some examples, the method of FIG. 2 includes forming a plurality of coated laminates (30). FIG. 3A is a cross-sectional diagram of an example coated laminate 50A (referred to generally as “coated laminate 50”). The plurality of coated laminates will be described with respect to coated laminate 50A; however, it will be understood that other coated laminates may include the properties as described with respect to coated laminate 50A.

Coated laminate 50A may include a laminate 52A. Laminate 52A may have a relatively thin, plate-like shape, such as illustrated in FIG. 1B. Laminate 52A may be composed of any suitable magnetically-permeable material, and may be composed of an alloy containing iron as a primary constituent, such an electrical steels. In some examples, laminate 52A may be composed of an alloy containing both iron and cobalt as its primary constituents (referred to here as an “Fe—Co alloy”). The Fe—Co alloy may contain lesser amounts other metallic or non-metallic constituents, such as carbon, silicon, niobium, manganese, and/or vanadium. In some examples, laminate 52A may have a thickness between about 100 microns (μm) and about 400 μm.

Laminate 52A may be formed by any suitable method. In some examples, laminate 52A may be formed by cutting a desired laminate shape from a sheet or panel of magnetically-permeable material, which may include any material removal process such as etching, Electrical Discharge Machining (EDM) cutting, laser cutting, and the like. In some examples, laminate 52A may be formed from a magnetically-permeable sheet material using a photo-etching process to impart low stress on the laminates 52 and reduce or eliminate formation of burrs. In some examples, a ferric chloride (FeCl₃) etch chemistry may be employed when the magnetically-permeable sheet material is composed of an Fe—Co alloy of the type described above.

In some examples, coated laminate 50A may include an oxidation barrier layer (not shown). The oxidation barrier layer may be composed of any material that decreases a propensity of laminate 52A to oxidize when exposed to air or another oxidizing ambient at elevated temperatures. The oxidation barrier layer may be formed using a variety of methods including, but not limited to: plating metal (e.g., nickel) over surfaces of laminate 52A, such as through an electrolytic or an electroless plating process; forming a Thermally-Grown Oxide (TGO) layer over laminate 52A by heating laminate 52A to an elevated temperature in an oxidizing atmosphere, such as between about 500° C. and about 600° C. (e.g., in a pre-firing step as described in FIG. 2); and the like. In some examples, surfaces of laminate 52A may be pre-roughed using, for example, a chemical etch, a wet blast, or another roughening technique, prior to application of the oxidation barrier layer to promote adhesion to laminate 52A. The oxidation barrier layer may have a thickness between about 0.1 and about 10.0 μm, such as between about 1 and about 3 μm.

In some examples, the method of FIG. 2 includes coating one or more precursor layers on a plurality of laminates to form a plurality of coated laminates (32). Coated laminate 50A may include one or more precursor layers, illustrated in FIG. 3A as a top precursor layer 54A and a bottom precursor layer 56A. However, in other examples, coated laminate 50A may include a single precursor layer, as a second precursor layer may be positioned beneath laminate 52A during a stacking process.

Top precursor layer 54A overlies a first major surface 53A of laminate 52A and bottom precursor layer 56A overlies a second major surface 55A of laminate 52A. Precursor layers 54A and 56A may contain an inorganic dielectric material in particulate form. In some examples, the inorganic dielectric particles may include low melt glass particles that have a softening temperature and/or a melting temperature that is less than the melting temperature of a magnetically-permeable material from which laminate 52A may be produced. In other examples, other types of inorganic dielectric particles may be contained within the precursor material, providing that the inorganic dielectric particles may be consolidated into interlaminate dielectric layers during a consolidative firing process described below.

In some examples, the inorganic dielectric (e.g., glass) particles contained within precursor layers 54A and 56A may be chemically compatible with laminate 52A, such that interlaminate dielectric layers produced by consolidating the inorganic dielectric particles may be resistant to laminate ion migration. In some examples, a coefficient of thermal expansion (CTE) of the inorganic dielectric particles may be matched to a CTE of laminate 52A, such as between about 10 and about 20 parts per million per degree Celsius (PPM per ° C.). In some examples, a CTE of the inorganic dielectric particles may be less than or equal to a CTE of laminate 52A, which may range from about 10 PPM per ° C. to about 20 PPM per ° C. In some examples, the CTE of the inorganic dielectric particles may be greater than about 7 PPM per ° C. In some examples, the inorganic dielectric (e.g., glass) particles may be “ceramic-on-metal dielectric” material. For examples a ceramic-on-metal dielectric material may be formulated for use with a Fe—Co alloy as the laminate material. In some examples, a ceramic-on-metal dielectric material may be modified by addition of one or more refining ingredients to produce a precursor material, which may be applied onto laminate 52A, dried, and possibly pre-fired to form precursor layers 54A and 56A.

Precursor layers 54A and 56A may be applied to laminate 52A using a variety of methods. Prior to being pre-fired, precursor layers 54A and/or 56A may include a binder and the glass particles described above. In some examples, precursor layers 54A and/or 56A may be applied to laminate 52A using a wet state application technique. A wet state coating precursor material may include inorganic dielectric particles dispersed within an organic binder, such as ethyl cellulose or an acrylic. The organic binder may make the formulation printable and provide precursor layers 54A and/or 56A with green strength during handling. Additionally, the wet state coating precursor material may contain a solvent or liquid carrier transforming the precursor material to a wet or flowable state. Suitable solvents or liquid carriers include high molecular weight alcohols resistant to evaporation at room temperature, such as alpha-terpineol or TEXINOL®. The volume of solvent or liquid carrier contained within the coating precursor material can be adjusted to tailor of the viscosity of the precursor material to the selected wet state application technique. For example, in embodiments wherein the precursor material is applied by screen printing or doctor blading, the coating precursor material may contain sufficient liquid to create a paste or slurry.

In some examples, screen printing may be used as a wet state application technique to provide thickness uniformity and reduce waste. To coat laminate 52A in precursor layers 54A and 56A, a glass-containing paste may be applied to laminate 52A at a predetermined thickness (e.g., between 10 and 20 μm), which may be approximately twice a final desired thickness of the interlaminate dielectric layers produced from the precursor layers 54A and 56A. In some examples, a paste layer can be printed in a pattern providing less than 100% surface area coverage providing that non-covered areas are small enough the inorganic dielectric (e.g., glass) particles would flow over entire substrate when wet, fired, or pressed, as described below. In some examples, wet state application techniques other than screen printing can also be employed to apply precursor layers 54A and 56A to laminate 52A including, but not limited to, spraying and drying, dipping and drying, and doctor blade application.

In some examples, precursor layers 54A and/or 56A may be applied to laminate 52A using a dry state application technique. Precursor layers 54A and/or 56A may be deposited (e.g., screen printed or doctor bladed) and dried onto a temporary substrate or carrier, such as a tape backing (e.g., a strip of Mylar®). In this case, the binder content of the coating precursor material may be increased to, for example, about 8-10 weight percent (wt. %) for additional strength. Precursor layer 54 or 56 and the tape backing may be positioned over laminate 52A and inverted to place the respective precursor layer 54 or 56 in contact with laminate 52A. Heat and/or pressure may be applied to adhere the respective precursor layer 54A or 56A to laminate 52A and allow removal of the tape backing by, for example, physically peeling the tape away.

In some examples, precursor layers 54A and/or 56A may be deposited on laminate 52A after the laminate shape has been cut from a magnetically permeable sheet or panel (referred to here as “laminate singulation”). In some examples, precursor layers 54A and/or 56A may be formed over laminate 52A prior to laminate singulation and while laminate 52A remains interconnected with the other laminates as a relatively large, continuous panel. In such examples, laminate 52A may then be cut from the panel as described in step 30 above. As a result, each coated laminate 50 of the plurality of coated laminates 50 includes a laminate 52 coated with a precursor layer 54 and/or 56.

In some examples, the method of FIG. 2 includes stacking a plurality of coated laminates to form a stacked laminate core preform (34). FIG. 3B is a cross-sectional diagram of two example coated laminates 50A and 50B. Coated laminate 50A may be arranged in a laminate stack with a number of other laminates, such as coated laminate 50B illustrated in FIG. 3B. During stacking, the coated laminates 50 may be arranged in a vertically overlapping relationship such that laminates 52 may be interspersed with or interleaved with precursor layers 54 and 56. For example, a fixture such as locating pins or other register features may be used to ensure proper vertical alignment of coated laminates 50. Coated laminate 50B may be placed in contact with precursor layer 54A and/or 56A of coated laminate 50A and aligned with coated laminate 50A. This placement and alignment may be repeated until a desired number of laminates 52 (e.g., a few dozen to several hundred laminates) have been stacked to form a stacked laminated core preform. FIG. 3C is a cross-sectional diagram of a stacked laminate core preform 58. The stacked laminate core preform defines a plurality of open cavities, such as illustrated in FIG. 1B.

In some examples, the method includes pre-firing the stacked laminate core preform (36) or, alternatively, the plurality of coated laminates prior to stacking (not shown) to substantially remove the binder from the precursor layer. During pre-firing, stacked laminate core preform 58 may be subject to a pre-firing process that enables organic materials contained within precursor layers 54A and/or 56A to be decomposed or burned-out after or prior to laminate stacking. In some examples, coated laminate 50A and/or stacked laminate core preform 58 may be heated to a predetermined maximum temperature for a time period sufficient to decompose substantially all organic material from the coating precursor layers, such as at least 99 wt. % of the organic material from the coating precursor materials. In certain embodiments, pre-firing may be performed at highly elevated temperatures (e.g., from about 700° C. to about 850° C.) sufficient to glaze, sinter, or slightly melt the inorganic dielectric particles to help strengthen the post-fired coating precursor layers, which may otherwise be weakened when the organic binder is decomposed therefrom. Such highly elevated temperatures may cause sintering of the inorganic dielectric (e.g., glass) particles are referred to herein as “sintering temperatures.” However, precursor layers 54A and/or 56A may still be considered to contain inorganic dielectric particles even when the particles are partially merged or sintered together as a result of such a pre-firing process. In some examples, pre-firing coated laminate 50A at such temperatures may heat treat laminate 52A; in other examples, laminate 52A may be heat treated in an independent heat treatment step or during a consolidative firing process described below. In some examples, the pre-firing process may form an oxidation barrier layer.

In some examples, such as shown in FIG. 2, the plurality of coated laminates 50 may be pre-fired after the stacking and prior to firing the stacked laminate core preform, as a binder or other organic material may still be present in precursor layers 54 and/or 56. Stacked laminate core preform 58 may be exposed to a first predetermined temperature threshold for a sufficient period of time to decompose the organic material from precursor layers 54 and 56, such as between about 400° C. and about 600° C. During this phase, a relatively light convergent force may be applied to stacked laminate core preform 58 to maintain a relative positioning of laminates 52, while still permitting the ingress of oxygen to promote organic material burnout. In the stack however it takes overnight (16 hours) because oxygen diffuses in very slowly from the edge. In some examples, pre-firing may be performed under process conditions sufficient to remove substantially all organic material from precursor layers 54 and/or 56, such that the interlaminate dielectric layers described below may be substantially devoid of the binder or any other organic material, such as less than about 0.1 wt. % organic material.

In some examples, such as shown in FIG. 2, the plurality of coated laminates 50 may be pre-fired prior to both the stacking and firing the stacked laminate core preform. Pre-firing prior to stacking coated laminates 50A may shorten the manufacturing process by avoiding pre-firing during a consolidative firing process when precursor layers 54 and 56 may be largely shielded from the ingress of oxygen. In some examples, pre-firing may involve heating the coated laminates to elevated temperatures at which the binder (and any other organic materials) in the precursor materials decomposes, while exposing coated laminate 50A to air or another oxygen-containing environment. Pre-firing may be performed in a relatively short period of time on the order of, for example, 30 to 60 minutes.

In some examples, the method of FIG. 2 includes firing the stacked laminate core preform at a temperature above the softening point of the glass particles to form a low porosity rotor core (38). FIG. 3D is a cross-sectional diagram of a low porosity rotor core 14. During this consolidative firing process, stacked laminate core preform 58 may be subject to compressive loads and elevated temperatures sufficient to consolidate the inorganic dielectric (e.g., glass) particles contained within precursor layers 54 and 56 into coherent interlaminate dielectric layers 60, which may be interleaved or interspersed with coated laminates 50 in an alternating arrangement. For example, stacked laminate core preform 58 may be enclosed in a furnace jacket (e.g., a vacuum furnace) and a controlled compressive load (e.g., about 23 psi) may be exerted, such as by a hydraulic press, on stacked laminate core preform 58 while stacked laminate core preform 58 is heated to elevated temperatures in accordance with a predetermined heating schedule. In some examples, the compressive load may be varied during the consolidative firing process. For example, such as an example in which a binder remains in precursor layers 54 and/or 56 at the time of consolidative firing, a relatively light compressive load may initially be applied until the binder softens to a plastic flow state. Afterwards, precursor layers 54 and/or 56 may be leveled by increasing the compressive load. The compressive load may then be reduced during pre-firing (if not previously performed), and then again increased to remove voiding during consolidation of precursor layers 54 and 56 into coherent interlaminate dielectric layers 60. Finally, the compressive load may be reduced to a zero value during the cool down cycle.

Stacked laminate core preform 58 may be fired to a second predetermined temperature threshold exceeding the first temperature threshold used for pre-firing to melt or sinter the inorganic dielectric particles to the laminate material. The second predetermined temperature threshold may be equivalent to or greater than a softening temperature of the inorganic dielectric (e.g., glass) particles contained within precursor layers 54 and/or 56 and less than the melting temperature of the laminate material of laminate 52. In some examples, the second predetermined temperature threshold may be greater than the melting point of the inorganic dielectric particles, which may be, for example, approximately 100° C. greater than the softening temperature of the particles. In some examples, the second predetermined temperature threshold may be from about 770° C. to about 860° C., and may be achieved in vacuum, nitrogen, or inert atmosphere.

After the second temperature threshold is reached, the compressive load exerted on stacked laminate core preform 58 may be increased to cause the inorganic dielectric particles contained within precursor layers 54 and/or 56 to flow into voids between adjacent laminates 52, merge, and ultimately form a number of coherent interlaminate dielectric layers 60 between laminates 52. Interlaminate dielectric layers 60 may be densified (less porous) as compared to precursor layers 54 and/or 56 and may be substantially void free. Interlaminate dielectric layers 60 may be interspersed or interleaved with laminates 52 in a vertically alternating relationship. Interlaminate dielectric layers 60 may provide electrical insulation between neighboring laminates 52 included within rotor core 14 and bond the adjacent laminates 52 together. Additional firing cycles may be performed, as needed. In some examples, if laminates 52 have not been subjected to a metal heat treatment step, the consolidative firing process described in Step 38 may also be controlled to heat treat the metal laminates 52 as part of the consolidative firing process.

A final thickness of the interlaminate dielectric layers may range from about 5 to about 25 μm after consolidative firing. A thickness of interlaminate dielectric layers 60 may be less than a thickness of precursor layers 54 and/or 56, which may have an initial thickness between about 10 and about 30 μm when applied utilizing a wet state application technique described above. In some examples, the compressive load and temperatures applied during the consolidative firing process may be controlled to reduce or prevent laminate contact with adjacent laminates 52 and impart the resulting interlaminate dielectric layers 60 with the desired final thickness.

In some examples, inorganic standoff particles may be added to precursor layers 54 and/or 56 to ensure that a minimum gap between the laminates is maintained. The inorganic standoff particles can be, for example, presorted, spherical particles having a softening point greater than the softening point and possibly greater than the melt point of the inorganic dielectric (e.g., glass) particles contained in the coating precursor material. Suitable materials include high melt glasses and ceramics, such as alumina. Inorganic dielectric spheres having a maximum diameter substantially equivalent to a desired vertical standoff may be embedded within precursor layers 54 and/or 56 by, for example, mixing the spheres into the coating precursor material prior to application onto laminates 52. During the consolidative firing process, the processing temperatures may be held below the softening temperature of the inorganic standoff particles to ensure the standoff particles maintain their rigidity and thus provide a physical spacer setting the vertical standoff between the laminates and defining the thickness of the resulting interlaminate dielectric layers 60.

As a result of the process of FIG. 2, low porosity rotor core 14 may include a plurality of laminates 52, each composed of a magnetically-permeable material, such as Fe—Co alloy. A plurality of interlaminate dielectric layers 60 may be interspersed or interposed with the plurality of laminates 52 in an alternating relationship. The plurality of interlaminate dielectric layers 60 may electrically insulate and bond together the plurality of laminates 52. The plurality of interlaminate dielectric layer 60 may also include a relatively low number of interlaminar voids in which a molten conductive material may flow. The plurality of interlaminate dielectric layers 60 is composed of consolidated glass particles. The glass particles may have a softening temperature less than the melting temperature of the magnetically-permeable material, and may have a CTE less than a CTE of the magnetically-permeable material of the plurality of laminates 52. FIG. 3E is a side view diagram of an example low porosity rotor core 14. Low porosity rotor core 14 includes a generally cylindrical body a plurality of longitudinal rotor teeth 62 extending longitudinally along rotor core 14, and a plurality of longitudinal open cavities 64 extending longitudinally along rotor core 14 between the plurality of longitudinal rotor teeth 62. The plurality of longitudinal rotor teeth 62 are produced from the overlapping or aligning plurality of rotor teeth 22 of the individual laminates included within rotor core 14, such as illustrated in FIG. 1B.

In some examples, the method includes casting a conductive material into the plurality of open cavities formed in rotor core to define a conductive squirrel cage structure in the low porosity rotor core. For example, a conductive material, such as aluminum or copper, may be melted and flowed under pressure into the plurality of longitudinal open cavities 64 illustrated in FIG. 3E. In some examples, the conductive material may have a lower melting point than a softening temperature of the material of interlaminate dielectric layers between laminates 52. For example, a glass used for the interlaminate dielectric layers may soften in a range of about 750-850° C. Copper may have a melting point of about 1085° C. and aluminum may have a melting point of about 660° C. If copper is cast into the plurality of open cavities in a liquid state, the liquid copper may soften the interlaminate dielectric layers between laminates 52, thereby reducing an integrity of rotor core 14. However, if aluminum is cast into the plurality of open cavities in a liquid state, the liquid aluminum may not soften the interlaminate dielectric layers between 52, thereby maintaining an integrity of rotor core 14. You need to have a metal which melts below the softening point of the glass dielectric to maintain stack integrity. Due to the low porosity interlaminate dielectric layers formed between laminates 52, the conductive material may not substantially infiltrate pores in laminate 52 and/or interlaminar voids between laminates 52, and may be substantially limited to the plurality of longitudinal open cavities 64.

The conductive material in the plurality of longitudinal open cavities 64 may be cooled and solidified to form the plurality of rotor bars 20 and shorting rings 18. FIG. 3F is a side view diagram of an example squirrel cage structure 16 formed from the example low porosity rotor core 14 of FIG. 3E. The plurality of rotor bars 20 may be substantially electrically isolated from/uncoupled with adjacent rotor bars. As a result, a rotor formed from the low porosity rotor core 14 and squirrel cage structure 16 may have improved efficiency and/or be manufactured with improved yield compared to rotors that do not include low porosity rotor cores.

In this manner, inorganic dielectric materials, such as a low melt glass, can be used to electrically insulate and bond laminates 52 into low porosity rotor core 14 and seal pores and other gaps in and between laminates 52 through which the conductive material may flow during formation of squirrel cage structure 16. The resulting low porosity rotor core 14 may be substantially devoid of bridging between rotor bars.

Various examples have been described. These and other examples are within the scope of the following claims.

What is claimed is:

1. A method for forming a squirrel cage rotor, the method comprising:
stacking a plurality of coated laminates to form a stacked laminate core preform, wherein the stacked laminate core preform defines a plurality of open cavities, wherein each coated laminate of the plurality of coated laminates includes a laminate coated with one or more precursor layers, wherein the one or more precursor layers include a binder and glass particles;
firing the stacked laminate core preform at a temperature above a softening temperature of the glass particles to form a low porosity rotor core; and
casting a conductive material into the plurality of open cavities formed in the rotor core to define a conductive squirrel cage structure in the low porosity rotor core.

2. The method of claim 1, further comprising, after the stacking and prior to firing the stacked laminate core preform, pre-firing the plurality of coated laminates to substantially remove the binder from the precursor layer.

3. The method of claim 1, further comprising, prior to the stacking and the firing the stacked laminate core preform, pre-firing the plurality of coated laminates to substantially remove the binder from the precursor layer.

4. The method of claim 1, wherein the low porosity rotor core has a porosity of less than about 5%.

5. The method of claim 1, wherein the precursor layer of at least one coated laminate of the plurality of coated laminates includes a first precursor layer on a first major surface of the laminate and a second precursor layer on a second major surface of the laminate.

6. The method of claim 1, wherein the conductive material has a melting point that is less than the softening temperature of the glass particles.

7. The method of claim 1, wherein each laminate of the plurality of laminates includes a magnetically-permeable material.

8. The method of claim 7, wherein the magnetically-permeable material comprises an iron-cobalt alloy.

9. The method of claim 1, further comprising coating a plurality of laminates with the one or more precursor layers to form the plurality of coated laminates.

10. The method of claim 9, wherein coating the laminates further comprises screen printing the one or more precursor layers.

11. The method of claim 1, wherein the rotor core comprises a plurality of rotor teeth, and wherein a width of each rotor tooth of the plurality of rotor teeth is less than about 0.1 inches.

12. The method of claim 7, wherein a CTE of the glass particles is less than a CTE of the magnetically-permeable material.

13. A squirrel cage rotor, comprising:
a rotor core comprising:
a plurality of laminates, wherein each laminate of the plurality of laminates includes a magnetically-permeable material; and
a plurality of interlaminate dielectric layers interspersed or interposed with the plurality of laminates in an alternating relationship, wherein the plurality of interlaminate dielectric layers includes glass particles; and
a squirrel cage structure comprising distal and proximal shorting rings and a plurality of rotor bars extending longitudinally along the rotor core between the distal and proximal shorting rings.

14. The squirrel cage rotor of claim 13, wherein the low porosity rotor core has a porosity of less than about 5%.

15. The squirrel cage rotor of claim 13, wherein the magnetically-permeable material comprises an iron-cobalt alloy.

16. The squirrel cage rotor of claim 13, wherein the plurality of interlaminate dielectric layers electrically insulates and bonds together the plurality of laminates.

17. The squirrel cage rotor of claim 13, wherein a softening temperature of the glass particles is less than a melting temperature of the magnetically-permeable material.

18. The squirrel cage rotor of claim 13, wherein a softening temperature of the glass particles is greater than a melting temperature of a conductive material of the plurality of rotor bars.

19. The squirrel cage rotor of claim 13, wherein a CTE of the glass particles is less than a CTE of the magnetically-permeable material.

20. The squirrel cage rotor of claim 13, wherein the rotor core comprises a plurality of rotor teeth, and wherein a width of each rotor tooth of the plurality of rotor teeth is less than about 0.1 inches.
